(19) United States
(12) Patent Application Publication
(10) Pub. No.: US 2017/0066056 A1
(43) Pub. Date: Mar. 9, 2017

(54) A New Method of Making a Cemented Carbide or Cermet Body

(71) Applicant: MASCHINENFABRIK GUSTAV EIRICH GMBH & CO. KG, Hardheim (DE)

(72) Inventors: Sofia Maria Ronnheden, Tungelsta (SE); Christopher Thompson, Stafford (GB); Peter George Fuller, Coventry (GB); Stefan Gerl, Werbach (DE)

(21) Appl. No.: 15/122,765

(22) PCT Filed: Jun. 9, 2015
(86) PCT No.: PCT/EP2015/062794

§ 371 Date: Aug. 31, 2016

(30) Foreign Application Priority Data
Jun. 12, 2014 (EP) 14172142.3

(51) Int. Cl. B22F 3/16; B22F 9/04; B22F 7/00

(52) U.S. Cl. CPC B22F 3/16; B22F 7/008; B22F 9/04; B22F 2201/20; B22F 2998/10; B22F 2009/041; B22F 2301/15; B22F 2302/10; B22F 2302/45; B22F 2302/40; B28B 1/24

(57) ABSTRACT

A method of manufacturing a cemented carbide and/or cermet comprising the steps of: a) providing a powder comprising metal carbide and binder metal and optionally metal nitride(s); b) mixing the powder composition under vacuum; c) adding at least one organic binder to the powder composition; d) mixing the at least one organic binder with the powder composition under vacuum and raising the temperature to a predetermined temperature and keeping the temperature for a predetermined time until the organic binder has melted; e) subjecting the obtained mixture of step d) to forming and sintering processes; wherein one or more dispersing agents is added to the powder composition in step a).

### TECHNICAL FIELD

The present invention relates to new method of manufacturing a cemented carbide or a cermet wherein the cemented carbide and/or cermet has a microstructure with improved homogeneity.

### BACKGROUND OF THE INVENTION

Cemented carbide or cermet is commonly used for rotary tools as it has good wear properties. In order to achieve optimal properties, the microstructure needs to contain as few clusters of enlarged hard metal grains as possible and also as few binder lakes as possible and additionally as little porosity as possible. EP1724363 A1 discloses the wet milling of a powder mixture containing hard constituent powder(s) based on carbides of Ti, Zr, Hf, V, Nb, Ta, Cr, Mo and/or W and >15 wt % binder phase powder(s) of Co and/or Ni as well as pressing agents and spray drying. 0.05-0.50 wt % of a complex forming and/or pH-increasing/decreasing additive, such as triethanolamine, hydroxides or acids, and a thickener in an amount of 0.01-0.10 wt % is added to the powder mixture before milling.

U.S. Pat. No. 5,922,978 A discloses a pressable powder being formed by a method comprising mixing, in essentially deoxygenated water, a first powder selected from the group consisting of a transition metal carbide and transition metal with an additional component selected from the group consisting of a second powder comprised of a transition metal carbide, transition metal or mixture thereof; an organic binder and combination thereof and drying the mixed mixture to form the pressable powder, wherein the second powder is chemically different than the first powder. The pressable powder may then be formed into a shaped part and subsequently densifed into a densifed part, such as a cemented tungsten carbide and triethanolamine could be added as a corrosion inhibitor.

U.S. Pat. No. 6,878,182 B2 discloses a slurry based on ethanol-water and contains metal carbide and metallic raw materials as well as stearic acid and a low concentration of polyethylenimine (PEI). The concentration of PEI is 0.01-1 wt % of the raw material weight.

EP1153652 A1 discloses a procedure of mixing WC and Co with additional constituents suitable for making cemented carbides, with water, ethanol or mixtures of ethanol and water, and a polyethylenimine-based dispersant to achieve a well dispersed suspension suitable for spray drying. The method is characterised in adding to the slurry as dispersant 0.1-10 wt %, preferably 0.1-1 wt %, of a polyethylenimine-based polyelectrolyte.

In all the above mentioned disclosures the dispersing agents, such as triethanolamine and/or polyethylenimine are added to a wet mixture or slurry. The problems with these methods are that mixing of the different constituents will be incomplete and the obtained products will therefore not have the desired homogenous microstructure when sintered and therefore not the desired properties step. The present invention will solve or at least reduce the above mentioned problems.

CN101892409 discloses a method of manufacturing a cemented carbide, in which method an organic binder, PEG, is added to a powder comprising metal carbide and binder metal.

### SUMMARY

In one aspect the present invention describes a method of manufacturing a cemented carbide or cermet comprising the steps of:
a) providing a powder comprising metal carbide(s) and binder metal(s) and optionally metal nitride(s);
b) mixing the powder composition under vacuum;
c) adding at least one organic binder to the powder composition;
d) mixing the at least one organic binder with the powder composition under vacuum and raising the temperature to a predetermined temperature and keeping the temperature for a predetermined time until the organic binder has melted;
e) subjecting the obtained mixture of step d) to forming and sintering processes; wherein one or more dispersing agents is added to the powder composition in step a).

Hence, at least one dispersing agent is added to the dry powder mixture in the first step.

In another aspect of the present disclosure, a cemented carbide or cermet body is obtained according to the hereinabove or hereinafter defined method, wherein the microstructure of the cemented carbide or the cermet has no clusters of hard metal grains with a diameter >5× the average hard metal grain size.

In another aspect a cemented carbide or cermet body obtained according to the method as defined herein above or hereinafter, which cemented carbide or cermet body is used for a rotary cutter or any other wear application.

The method described hereinabove or hereinafter will provide a desired homogenous powder mixture which in turn will results in a product (cemented carbide and/or cermet) with more homogenous microstructure and therefore having improved properties, for example increased tensile strength, increased hardness, increased fracture toughness and/or increased wear resistance. This consequently will result in an improvement in the performance when the cemented carbide and/or cermet is used for a rotary cutter or wear part.

### BRIEF DESCRIPTION OF DRAWINGS

FIG. 1: discloses optical micrograph showing microstructure of cemented carbide from test 1 showing an example of a hard metal cluster.

FIG. 2: discloses optical micrograph showing microstructure of cemented carbide from test 1 showing an example of binder lakes.

FIG. 3: discloses optical micrograph showing microstructure of cemented carbide from test 3

FIG. 4: discloses optical micrograph showing microstructure of cemented carbide from test 8

All the optical micrographs were taken on Olympus PMG3-LSH-3 inverted microscope.

### DETAILED DESCRIPTION

According to a first aspect of the disclosure there is provided a method of manufacturing a cemented carbide and/or cermet comprising the steps of:
a) providing a powder comprising metal carbide(s) and binder metal(s) and optionally metal nitride(s);
b) mixing the powder composition under vacuum;
c) adding at least one organic binder to the powder composition;
d) mixing the at least one organic binder with the powder composition under vacuum and raising the temperature to a predetermined temperature and keeping the temperature for a predetermined time until the organic binder has melted;
e) subjecting the obtained mixture of step d) to forming and sintering processes;

wherein one or more dispersing agents is added to the powder composition in step a).

According to the present method as defined hereinabove or hereinafter, one or more cooling agents is optionally added to the powder composition in step b).

The method of the first aspect of the disclosure preferably comprises making a dough for use in extrusion. In such a case, the method preferably comprises adding organic solvents (mono propylene glycol (MPG) and/or Oleic acid) to the mixture obtained so as to lubricate mixture prior to sintering in step e) above.

Additionally, according to the present method, the one or more dispersing agents is selected from triethanol amine (TEA) or polyethylene imine (PEI) or a mixture thereof.

Further, according to the present method as defined hereinabove or hereinafter, the powder provided in step a) comprises metal carbide(s) and binder metal(s) and metal nitride(s).

When adding at least one organic binder to the cemented carbide or cermet production process, a two-step mixing process is necessary. This is because if the metal carbide powder, the metal nitride powder, binder metal powder and organic binder(s) are mixed together in the single step, the organic binder will stick to the binder metal powder, which will prevent efficient mixing and consequently will provide a cemented carbide or cermet with a non-homogenous microstructure. The desired homogeneity of the microstructure of the cemented carbide or cermet is obtained by adding one or more dispersing agents to the powder composition thus ensuring that the composition is well mixed before the at least one organic binder is added.

The present disclosure provides an effective method for obtaining cemented carbides or cermets having a homogenous mixture as the one or more dispersing agents is added to the first mixing step (step a) wherein powders of the metal carbide(s) and binder metal(s) and optionally metal nitride(s) are mixed in dry form. Thus, this mixing step is a dry mixing step having a moisture content of less than or equal to 5 wt % (based on the total powder composition). The mixing step is defined as dry in that no significant quantities of water and/or ethanol and/or any other solvent are added to produce a wet slurry. The only liquid added in this step is, if necessary, a small quantity liquid in the form of cooling agent. The cooling agent is selected from water, ethanol and any other suitable solvent which would readily evaporate under the mixing conditions. The temperature at this first mixing step needs to be maintained to below 50° C. to avoid oxidation. The powder composition should be kept as dry as possible during this first mixing step, therefore the moisture content is less than or equal to 5 wt %. No cooling agent is added until the temperature starts to rise above 50° C. and when the temperature starts to rise, the amount of cooling agent added should be as little as possible in order to keep the powder mixture as dry as possible, i.e. with a moisture content less than or equal to 5 wt %. During this step, the one or more dispersing agents are added. The addition of the one or more dispersing agents in this step ensures that the powders of metal carbide(s) and binder metal(s) and optionally metal nitride(s) are well mixed before the at least one organic binder is added in the second mixing step.

The one or more dispersing agents is selected from triethanol amine (TEA), polyethylene imine (PEI) or a mixture thereof. The amount of dispersing agent is of from 0.05-0.5 wt % of total powder mixture.

According to the present method, the cemented carbide comprises metal carbide(s) and/or metal nitride(s) in the range of from 70 to 97 wt % and binder metal(s) in the range of from 3 wt % to 30 wt % (the wt % is based on the total content of the cemented carbide). The metal carbide(s) and/or metal nitride(s) comprises more than or equal to70 wt % tungsten carbide and less than or equal 30 wt % of at least one other metal carbide and/or metal nitride selected from titanium carbide, titanium nitride, tantalum carbide, tantalum nitride, niobium carbide and a mixture thereof (the wt % is based on the total content of metal carbides and metal nitrides)

According to the present method, the cermet comprises metal carbide(s) and/or metal nitride(s) in the range of from 70 to 97 wt % and binder metal in the range of from 3 wt % to 30 wt % (the wt % is based on the total content of the cermet). Further, the cermet comprises a combination of one or more metal carbides and/or metal nitrides selected from titanium carbide, titanium nitride, tungsten carbide, tantalum carbide, niobium carbide, vanadium carbide, molybdenum carbide, chromium carbide and a mixture thereof, with the highest proportion being titanium based, i.e. the titanium is in the form of carbide and/or nitride and is in the range of from 30 to 60 wt % (the wt % is based on the total content of the cermet). Further, the cermet does not comprise any free hexagonal tungsten carbide. The cermet comprises tungsten carbide without any free hexagonal structure in the range of from 10 to 20 wt %. Hexagonal tungsten carbide has a structure made up of a simple hexagonal lattice of tungsten atoms layered directly over one another with the carbon atoms filling half the interstices giving both tungsten and carbon a regular trigonal prismatic structure.

The cermet and/or cemented carbide may also comprise small amounts, such as less than or equal to 3 wt % of other compounds e.g. MoC, VC, and/or Cr₃C₂.

According to the present disclosure, the binder metal(s) is selected from cobalt, molybdenum, iron, chromium or nickel and a mixture thereof.

According to the method as defined hereinabove or hereinafter, one or more organic solvents is optionally added in step d).

The method as defined herein above or hereinafter, optionally comprises that the obtained mixture of step d) is dried after the forming and prior to sintering in step e).

According to the present disclosure, the forming is performed by using extrusion, pressing operation or injection moulding.

In the first mixing stage, the metal carbide(s) and/or metal nitride(s) may be selected from the group of tungsten carbide, tantalum carbide, niobium carbide, titanium carbide, titanium nitride, tantalum nitride, vanadium carbide, molybdenum carbide, chromium carbide and mixture thereof. The binder metal(s) is any of one single binder metal or a blend of two or more metals or an alloy of two or more metals and the binder metal are selected from cobalt, molybdenum, iron, chromium or nickel. However, which carbides and/or nitrides that are selected and the proportions thereof depends on if the final product will be a cemented carbide or a cermet and the desired final properties of the final product.

Once the components of the first mixing step are well mixed one or more organic binders are added. The at least one organic binder used in the process as defined hereinabove or hereinafter is selected from polyethylene glycol (PEG), methyl cellulose (MC), wax systems such as petroleum wax, vegetable wax or synthetic wax, polyvinyl butyral (PVB), polyvinyl alcohol (PVA) and a mixture thereof. The organic binder could also be a mixture of the same organic binder but of different types e.g. a mixture of different PVA, PEG or MC.

In this second step, the mixing is continued under vacuum (to avoid trapped air in the mixture) until the temperature reaches approximately 70° C. (or higher depending upon the organic binder) to ensure that organic binders have melted or are fully dispersed. If a dough is to be produced, for example if the cemented carbide or cermet is to be formed using an extrusion process, then additional wet organic solvents such as oleic acid, monopropylene glycol or water may also be added in the second mixing step. In this case, an additional drying step would be required after forming and prior to sintering.

According to the present method, the mixing may be performed by using a planetary mixer. A planetary mixer contains blades which rotate on their own axes, and at the same time on a common axis, thereby providing complete mixing in a short timeframe. A ball milling stage is not required. The benefit of this type of mixer is that it means that compared to the conventional ball milling commonly used to mix powders to be used for obtaining cemented carbides and cermets, the mixing time is reduced and there is no attrition of the raw materials. Other high speed mixing devices could also be used for example high speed rotor.

According to a second aspect of the disclosure there is provided a cemeneted carbide or cermet in accordance with claim 11. Preferably, in one aspect the cemented carbide or cermet obtained has a microstructure with no clusters of metal grains with a diameter >5× the average hard metal grain size. According to the method as defined hereinabove or hereinafter, the cemented carbide and/or cermet which is obtained thereby has a microstructure comprising no clusters of enlarged hard metal grains with a diameter greater than 5× the average hard metal grain size and no more than 0.5 per cm². The average hard metal grain size is determined using the linear intercept method according to ISO standard 4499. A cluster is defined as 5 or more grains located next to each other. An example is shown in FIG. 1.

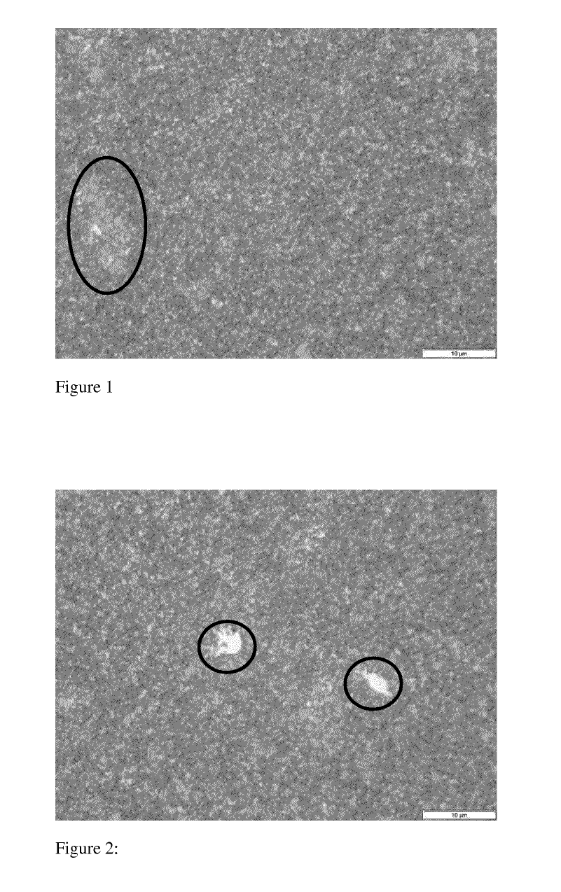

In another aspect, the microstructure cemented carbide or cermet has no binder lakes with a diameter >5× the average hard metal grain size. Further, according to the method as defined hereinabove or hereinafter, the cemented carbide and/or cermet obtained thereby has a microstructure comprising no binder lakes with a diameter greater than 5× the average hard metal grain size and no more than 0.5 cm per cm². A binder lake is defined as an area consisting of only binder with no hard metal grains in that region. An example is shown in FIG. 2.

In another aspect, the microstructure of the cemented carbide or cermet has A type porosity of A00 or A02. Additionally, according to the method as defined hereinabove or hereinafter, the cemented carbide and/or cermet body obtained thereby has a microstructure with A type porosity of A00 or A02. Porosity is measured according to ISO standard 4505. A type porosity is defined as voids less than 10 μm in diameter. A00 corresponds to the total absence of any porous volume and A02 means a maximum volume of A type pores of 0.02% of the total material volume.

According to a third aspect of the disclosure there is provided a use of a cemented carbide or cermet made in accordance with any one or more of claims 1 to 10, and/or a cemented carbide or cermet in accordance with claims 11 to 13, the cemented carbide or cermet preferably being used for a rotary cutter or any other wear application. The cemented carbide or cermet body obtained from the method as defined hereinabove or hereinafter may be used for a manufacturing a rotary cutter or any other wear object for example mining drill bits or can punch tooling.

According to a fourth aspect of the disclosure there is provided a method of manufacturing a cemented carbide and/or cermet ready to press (RTP) powder in accordance with claim 15.

The present invention is further illustrated by the following non-limiting examples.

### EXAMPLES

Table 1 outlines the different compositions used for mixing WC-Co cemented carbide. For all of these tests, the mixing was done in two steps using an Eirich™ Mixer, model RO2VAC.

Firstly, the tungsten carbide (WC), cobalt (Co), chromium carbide (Cr₃C₂), carbon (C) powders were mixed together. In tests 3 to 12, the TEA and/or PEI were also added in this step. The constituents were mixed by turning the rotor at 270 rpm whilst the vacuum was applied and then the first step of mixing was done for 20 minutes at 4500 rpm. Distilled water was added at a minimal amount to maintain a temperature of 50° C. when the temperature of the powder started to rise.

In the second mixing step, the dry organic constituents (PEG) were added and mixed in at 1500 rpm under vacuum until the temperature reached approximately 70° C. and all the PEG had melted, this took approximately 3 minutes. For tests 1 and 2, the TEA was also added at this step. The organic solvents, olaic acid and/or mono propylene glycol (MPG) were then also added and the mixing continued so that a dough was formed. The mixer was turned off when the rotor speed slowed down due to the viscosity of the material.

Samples from tests 1-12 were taken prior to the addition of the organic binders. A small amount of PEG 300 was added and the samples pressed to form 8×7×24 mm compacts and then sintered at 1450° C. at 50 Bar pressure. The sintered samples were mounted in resin and polished with 180 and then 220 μm grit. The porosity of the samples was examined under an optical microscope and assessed according to ISO standard 4505.

As can be seen in table 1 the A type porosity has significantly reduced in tests 3-12, where the dispersing agent was added in the first mixing step compared to tests 1 and 2, where the dispersing agent was added in the second mixing step.

The samples were then etched using Murikami's reagent for 4 minutes and then examined again under an optical microscope to assess the homogeneity of the microstructure. Tests 1 and 2 yielded cemented carbide bodies with microstructures which contained large clusters of enlarged hard metal grains and large binder lakes. For example FIGS. 1 and 2 show the microstructure of the cemented carbide body produced from test 1. FIG. 1 shows a cluster of grains which all have a grain size diameter of >5× the average hard metal grain size. The cluster measures approximately 14 μm across at the widest section. FIG. 2 shows binder lakes in the sample, one with a diameter of approximately 3.4 μm and the other with a diameter of approximately 4.1 μm, both greatly exceeding a diameter of 5× the average hard metal grain size.

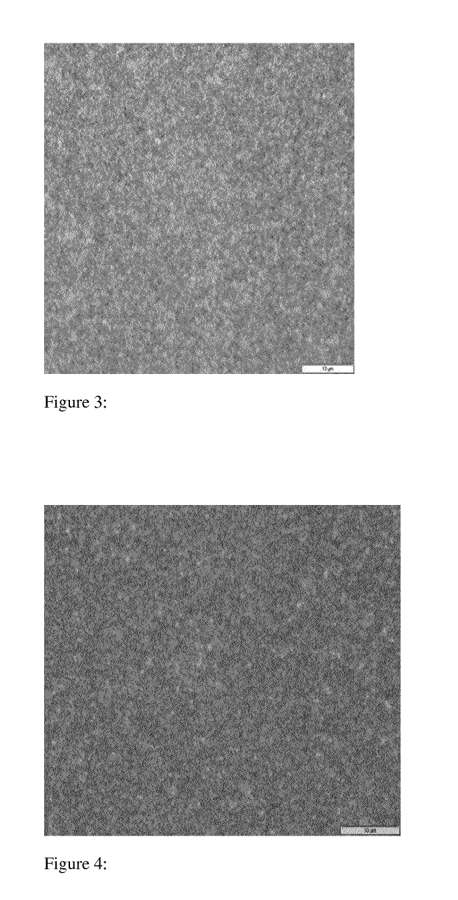

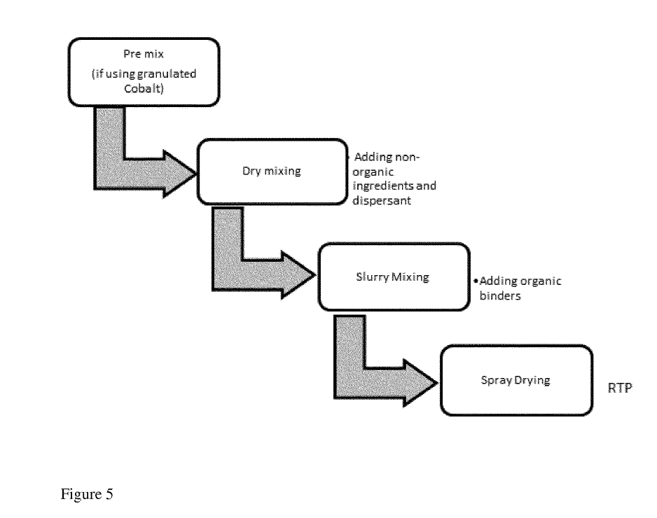

FIGS. 3 and 4 show examples of the microstructure for cemented carbide bodies from tests 3 and 8 respectively. It can be seen that the microstructures have good grain size uniformity, no clusters of enlarged hard metal grains and no binder lakes.

TABLE 1

| Constituents | | | | | | |
|---|---|---|---|---|---|---|
| (wt %) | Test 1 | Test 2 | Test 3 | Test 4 | Test 5 | Test 6 |
| WC004 | 82.22 | 0 | 82.47 | 82.12 | 82.48 | 82.15 |
| WC008 | 0 | 82.22 | 0.00 | 0.00 | 0.00 | 0.00 |
| Co | 9.21 | 9.21 | 9.22 | 9.18 | 9.22 | 9.18 |
| Cr₃C₂ | 0.46 | 0.46 | 0.46 | 0.46 | 0.46 | 0.46 |
| C | 0.05 | 0.02 | 0.05 | 0.05 | 0.05 | 0.05 |
| PEG | 5.3 | 5.3 | 5.3 | 5.3 | 5.3 | 5.3 |
| Solvent | 2.67 | 2.67 | 1.92 | 1.92 | 1.92 | 1.92 |
| TEA added | 0 | 0 | 0.10 | 0.50 | 0.00 | 0.00 |
| in first (dry) | | | | | | |
| mixing step | | | | | | |
| TEA added | 0.09 | 0.09 | 0.00 | 0.00 | 0.00 | 0.00 |
| in second | | | | | | |
| mixing step | | | | | | |
| PEI added in | 0 | 0 | 0.00 | 0.00 | 0.09 | 0.46 |
| first (dry) | | | | | | |
| mixing step | | | | | | |
| Porosity | A06B00C00 | A06B00C00 | A02B02C00 | A02B00C00 | A00B06C00 | A00B04C00 |
| Constituents | | | | | | |
| (wt %) | Test 7 | Test 8 | Test 9 | Test 10 | Test 11 | Test 12 |
| WC004 | 82.39 | 0.00 | 0.00 | 0.00 | 0.00 | 0.00 |
| WC008 | 0.00 | 82.49 | 82.13 | 82.50 | 82.17 | 82.41 |
| Co | 9.21 | 9.22 | 9.18 | 9.22 | 9.18 | 9.21 |
| Cr₃C₂ | 0.46 | 0.46 | 0.46 | 0.46 | 0.46 | 0.46 |
| C | 0.05 | 0.03 | 0.03 | 0.03 | 0.03 | 0.03 |
| PEG | 5.3 | 5.3 | 5.3 | 5.3 | 5.3 | 5.3 |
| Solvent | 1.92 | 1.92 | 1.92 | 1.92 | 1.92 | 1.92 |
| TEA added | 0.10 | 0.10 | 0.50 | 0.00 | 0.00 | 0.10 |
| in first (dry) | | | | | | |
| mixing step | | | | | | |
| TEA added | 0.00 | 0.00 | 0.00 | 0.00 | 0.00 | 0.00 |
| in second | | | | | | |
| mixing step | | | | | | |
| PEI added in | 0.09 | 0.00 | 0.00 | 0.09 | 0.46 | 0.09 |
| first (dry) | | | | | | |
| mixing step | | | | | | |
| Porosity | A02B00C00 | A00B02C04 | A00B02C02 | A00B02C02 | A00B02C02 | A00B02C02 |

Referring to FIG. 5, in another embodiment of the disclosure, a method of manufacturing a cemented carbide and/or cermet Ready to press (RTP) powder is disclosed.

The Ready to press cemented carbide or cermet powder (RTP) comprises “direct mixing” steps like some of the steps of the method of making a dough disclosed hereinabove. Like in the method of making a dough disclosed hereinabove, the term “direct mixing” refers to the elimination of a ball milling stage.

This disclosure describes, by way of non-limiting example only, the mixing of powder containing hard constituent powder(s) based on carbides of Ti, Zr, Hf, V, Nb, Ta, Cr, Mo and/or W and 3-30 wt % binder phase powder(s) of Co and/or Ni and/or Fe or alloys thereof.

The method of manufacturing a cemented carbide and/or cermet Ready to press (RTP) powder consists of a two stage mixing process followed by the more traditional spray drying process.

The first stage is a dry mixing stage with <5% moisture. In the first stage, the inorganic ingredients are intimately mixed with aid of a dispersant (triethanol amine (TEA) or polyethylene imine (PEI), or a mixture of the two).

Like in the method of making a dough disclosed hereinabove, a high shear mixer such as Eirich™ Mixer, model RO2VAC is used in step 1 of the method of manufacturing a cemented carbide and/or cermet Ready to press (RTP) powder.

Step 1 is done under vacuum, and water is added, as needed, purely to cool the powder (the water is evaporated during the process).

The mixing stage is described as dry in that no significant quantities of water and/or ethanol and/or any other solvent are added to produce wet slurry and the moisture content is <5%. The only liquid that is added at this stage is, if necessary, a small quantity of cooling agent. Cooling agent is used because the temperature of the mixture in the first mixing stage needs to be maintained to below about 50° C. to avoid oxidation. The powder is heated through friction due to the high speed of the mixing. The cooling agent is selected from water, ethanol or any other suitable solvent which would readily evaporate under the mixing conditions. As in the method of making a dough disclosed hereinabove, the evaporated cooling agent is removed from the vessel by the vacuum. The composition should be kept as dry as possible during the first mixing stage. No cooling agent should be added until the temperature starts to rise above 50° C. and when it does the amount of cooling agent added should be as little as possible to keep the mixture as dry as possible and with a moisture content <5%. During this stage, the at least one dispersing agent should also be added. The addition of the at least one dispersing agent to this stage of the mixing process ensures that the metal carbide and metal binder components are well mixed before organic binder is added in the second mixing stage. At least one dispersing agent is selected from triethanol amine (TEA), polyethylene imine (PEI) or a combination thereof. Typically 0.05-0.5 wt % of dispersing agent is added at the beginning of the mixing process. This mixing stage is complete after ˜20 minutes.

The aim of the second mixing stage is to produce a slurry which is suitable for spray drying.

In the second stage of mixing organic binders are added, dissolved and a slurry is made.

More specifically, 1-4 wt % of polyethyleyne glycol (PEG) of varying molecule weight (depending upon the required pressing properties of the spray dried powder) is added to the mixer. 20-30 wt % Ethanol containing 8-12% water is added. The mixer is run at high speed, without vacuum, for 20-40 minutes to ensure that the PEG has completely dissolved.

The resulting slurry from the second mixing stage is kept agitated and passed through a mesh to remove any undissolved PEG/coarse contaminants, in readiness for spray drying.

The slurry is subsequently spray dried to produce a free flowing ready to press powder.

In the above described method of making a dough and in the above described method of making RTP, ungranulated Cobalt is used. However, in further embodiments of the disclosure, it is envisaged that granulated Cobalt can be used as a starting form of Cobalt in relation to both the method of making a dough and the method of making RTP. Granulated Cobalt is more user friendly in that there are less air borne particles. If granulated Cobalt is used as the starting form of Cobalt, additional pre mixing steps are required, prior to the steps of the method of making a dough and the method of making RTP disclosed hereinabove.

A granulated cobalt powder needs to be de-granulated in order to be thoroughly mixed with the other constituent powder(s). This can be done by vigorously mixing the granulated cobalt powder with 15-30% water in a high shear orbital mixer such as Eirich™ Mixer, model RO2VAC, operating without vacuum. By running the mixer at high speed for 20-60 minutes, the mix is heated, the organic binder, PEG, is dissolved, and the cobalt granules are broken down. This process allows the de-granulated cobalt to be dispersed in the subsequent mixing stage.

The rest of the constituent powders can then be added and mixed under vacuum at high speed for the dry mixing stage.

1. A method of manufacturing a cemented carbide or cermet comprising the steps of:
a) providing a powder composition comprising metal carbide(s) and binder metal(s);
b) mixing the powder composition under vacuum;
c) adding at least one organic binder to the powder composition;
d) mixing the at least one organic binder with the powder composition under vacuum and raising the temperature to a predetermined temperature and keeping the temperature for a predetermined time until the organic binder has melted;
wherein one or more dispersing agents is added to the powder composition in step a).

2. The method according to claim 1 characterised in that one or more cooling agents is added to the powder composition in step b).

3. The method according to claim 1, wherein cemented carbide comprises more than or equal to 70 wt % tungsten carbide and not more than or equal to 30 wt % of at least one other metal carbide and/or metal nitride selected from titanium carbide, tantalum carbide, tantalum nitride, titanium nitride, niobium carbide, vanadium carbide, molybdenum carbide, chromium carbide and mixtures thereof.

4. The method according to claim 1, wherein cermet comprises titanium carbide, titanium nitride, tungsten carbide, tantalum carbide, tantalum nitride, niobium carbide, vanadium carbide, molybdenum carbide, chromium carbide, or a mixture thereof.

5. The method according to claim 1, wherein that binder metal(s) is selected from cobalt, molybdenum, iron, chromium or nickel and a mixture thereof.

6. The method according to claim 1, wherein that the mixing is performed by using a high shear mixer such as a high speed rotor mixer, or a planetary mixer.

7. The method according to claim 1, wherein one or more organic solvents is added in step d).

8. The method according to claim 1, wherein the obtained mixture of step d) is dried after the forming.

9. The method according to claim 1 wherein the one or more dispersing agents is selected from triethanol amine (TEA) or polyethylene imine (PEI) and a mixture thereof.

10. The method according to claim 1, wherein in the forming is performed by using extrusion, pressing operation or injection moulding.

11. A cemented carbide or cermet obtained according to the method claim 1, preferably wherein the micro structure of the cemented carbide or the cermet has no clusters of hard metal grains with a diameter >5× the average hard metal grain size.

12. The cemented carbide or cermet according to claim 11, characterised in that the microstructure cemented carbide or cermet body has no binder lakes with a diameter >5× the average hard metal grain size.

13. The cemented carbide or cermet according to claim 12, characterised in that the microstructure has A type porosity of A00 or A02.

14. (canceled)

15. A method of manufacturing a cemented carbide or cermet ready to press (RTP) powder, the method comprising the steps of:
a) providing a powder composition comprising metal carbide(s) and binder metal(s);
b) mixing the powder composition under vacuum;
c) adding water and/or ethanol to the powder composition to make a slurry,
d) adding at least one organic binder to the slurry;
e) mixing the at least one organic binder with the slurry;
f) spray drying the slurry to make a ready to press (RTP) powder,
wherein one or more dispersing agents is added to the powder composition in step a).

16. The method according to claim 1 wherein the powder comprising metal carbide(s) and binder metal(s) also comprises-metal nitride(s).

17. The method according to claim 1 wherein the powder composition is dry mixed under vacuum.

18. The method according to claim 1 further comprising:
e) subjecting the obtained mixture of step d) to forming and sintering processes; wherein one or more dispersing agents is added to the powder composition in step a).

19. The method according to claim 15 wherein the powder comprising metal carbide(s) and binder metal(s) also comprises-metal nitride(s).

20. The method according to claim 15 wherein the powder composition is dry mixed under vacuum.

21. The method according to claim 15 further comprising:
g) subjecting the obtained RTP) powder of step f) to forming and sintering processes.
